(19) United States
(12) Patent Application Publication
(10) Pub. No.: US 2012/0092583 A1
(43) Pub. Date: Apr. 19, 2012

(54) LIQUID CRYSTAL DISPLAY DEVICE

(75) Inventors: Atsuo Nakagawa, Mobara (JP); Eiji Oohira, Mobara (JP)

(73) Assignees: Panasonic Liquid Crystal Display Co., Ltd.; Hitachi Displays, Ltd.

(21) Appl. No.: 13/267,320

(22) Filed: Oct. 6, 2011

(30) Foreign Application Priority Data
Oct. 13, 2010 (JP) 2010-230798

(51) Int. Cl. G02F 1/13357

(52) U.S. Cl. 349/58

(57) ABSTRACT

The outer frame includes an engagement piece which is elastically deformable and engages with the inner frame, in which the engagement piece includes: a first portion, which is bent from the periphery wall portion to extend in a first direction; and a second portion, which extends in a second direction up to a leading end of the engagement piece, in which the first direction includes a direction which obliquely approaches the inner frame while separating from the liquid crystal display panel, in which the second direction includes a direction which separates from the liquid crystal display panel without approaching the inner frame, in which the inner frame is held between the second portion of the engagement piece and the bottom wall portion, and in which the second portion of the engagement piece engages with the inner frame.

### CROSS-REFERENCE TO RELATED APPLICATION

The present application claims priority from Japanese application JP 2010-230798 filed on Oct. 13, 2010, the content of which is hereby incorporated by reference into this application.

### BACKGROUND OF THE INVENTION

1. Field of the Invention

The present invention relates to a liquid crystal display device.

2. Description of the Related Art

There is known a liquid crystal display device having a structure in which a resin frame is arranged between a liquid crystal display panel and a metal frame. The metal frame protects the liquid crystal display panel, and the resin frame plays a role as a buffering member for preventing the liquid crystal display panel and the metal frame from being brought into direct contact with each other. Japanese Patent Application Laid-open No. 2009-31753 discloses a structure in which a protruding portion of the resin frame is formed to engage with a stepped portion of the metal frame.

In the structure of Japanese Patent Application Laid-open No. 2009-31753, the stepped portion of the metal frame does not have elasticity, and hence the entire metal frame is elastically deformed to fit the resin frame therein. Therefore, there have been problems in that a protruding length of the protruding portion cannot be enlarged, and the stepped portion is easily disengaged.

In this context, there may be conceived a structure in which a claw having elasticity is formed in the metal frame, and a leading end of the claw engages with the resin frame. However, in this case, there is a risk that the leading end of the claw scrapes the resin frame when the resin frame is fitted into the metal frame. Chips of the resin frame become floating foreign matters.

### SUMMARY OF THE INVENTION

The present invention has an object to provide a liquid crystal display device including an inner frame inside an outer frame, which is capable of preventing generation of chips of the inner frame in a fitting step and preventing the inner frame from being detached.

(1) A liquid crystal display device according to the present invention includes: a liquid crystal display panel; an inner frame, which is fixed to the liquid crystal display panel; a backlight unit, which is arranged inside the inner frame; and an outer frame, which is arranged outside the inner frame, in which the outer frame includes: a periphery wall portion, which surrounds the inner frame; an engagement piece, which is elastically deformable and engages with the inner frame; and a bottom wall portion, which is opposed to a surface of the inner frame on a side opposite to the liquid crystal display panel, in which the engagement piece includes: a first portion, which is bent from the periphery wall portion to extend in a first direction; and a second portion, which extends in a second direction up to a leading end of the engagement piece, in which the first direction includes a direction which obliquely approaches the inner frame while separating from the liquid crystal display panel, in which the second direction includes a direction which separates from the liquid crystal display panel without approaching the inner frame, in which the inner frame is held between the second portion of the engagement piece and the bottom wall portion, and in which the second portion of the engagement piece engages with the inner frame. According to the present invention, in the engagement piece, the second portion extends up to the leading end in a direction not approaching the inner frame, and hence when the inner frame is fitted into the outer frame, the leading end of the engagement piece is not brought into contact with the inner frame. Therefore, it is possible to prevent generation of chips of the inner frame in a fitting step. Further, the engagement piece can be elastically deformed to fit the inner frame into the outer frame, and hence engagement portions of the inner frame and the outer frame can be greatly ensured, and detachment of the inner frame can be prevented.

(2) In the liquid crystal display device according to the above-mentioned item (1), the leading end of the engagement piece may engage with the inner frame.

(3) In the liquid crystal display device according to the above-mentioned item (1), the second direction may include a direction which obliquely separates from the inner frame.

(4) In the liquid crystal display device according to the above-mentioned item (3), the second portion may engage with the inner frame at a portion avoiding the leading end of the engagement piece.

(5) In the liquid crystal display device according to the above-mentioned item (1), the engagement piece may further include a third portion between the first portion and the second portion.

(6) In the liquid crystal display device according to the above-mentioned item (5), the third portion may extend in a third direction from the first portion to the second portion, the third direction including a direction which separates from the liquid crystal display panel without approaching the inner frame.

(7) In the liquid crystal display device according to the above-mentioned item (6), the second portion may engage with the inner frame at a portion avoiding the leading end of the engagement piece.

(8) In the liquid crystal display device according to anyone of the above-mentioned items (1) to (7), the inner frame may have a side surface including a surface opposed to the engagement piece, the side surface may include a recessed and projected portion formed so that a recessed portion is positioned on the liquid crystal display panel side, and the engagement piece may engage with a projected portion of the recessed and projected portion.

(9) In the liquid crystal display device according to anyone of the above-mentioned items (1) to (8), the engagement piece may be cut off from the periphery wall portion except for a portion connected to the periphery wall portion.

(10) In the liquid crystal display device according to any one of the above-mentioned items (1) to (9), the outer frame may include a pair of opposed engagement pieces.

(11) In the liquid crystal display device according to the above-mentioned item (10), when an interval between the pair of opposed engagement pieces becomes larger than an interval in a state before the inner frame is fitted into the outer frame, the engagement piece may be elastically deformed, and an elastic force may be applied to the inner frame from the engagement piece.

### BRIEF DESCRIPTION OF THE DRAWINGS

In the accompanying drawings:

FIG. 1 is a perspective view illustrating a part of a liquid crystal display device according to an embodiment of the present invention;

FIG. 2 is a sectional view taken along the line II-II of the liquid crystal display device partially illustrated in FIG. 1;

FIG. 3 is a view illustrating an inner frame and an outer frame under a state in which the inner frame and the outer frame are detached from each other;

FIG. 4 is a view illustrating a liquid crystal display device according to a first modification example of the embodiment of the present invention; and

FIG. 5 is a view illustrating a liquid crystal display device according to a second modification example of the embodiment of the present invention.

### DETAILED DESCRIPTION OF THE INVENTION

Hereinafter, an embodiment of the present invention is described with reference to the drawings.

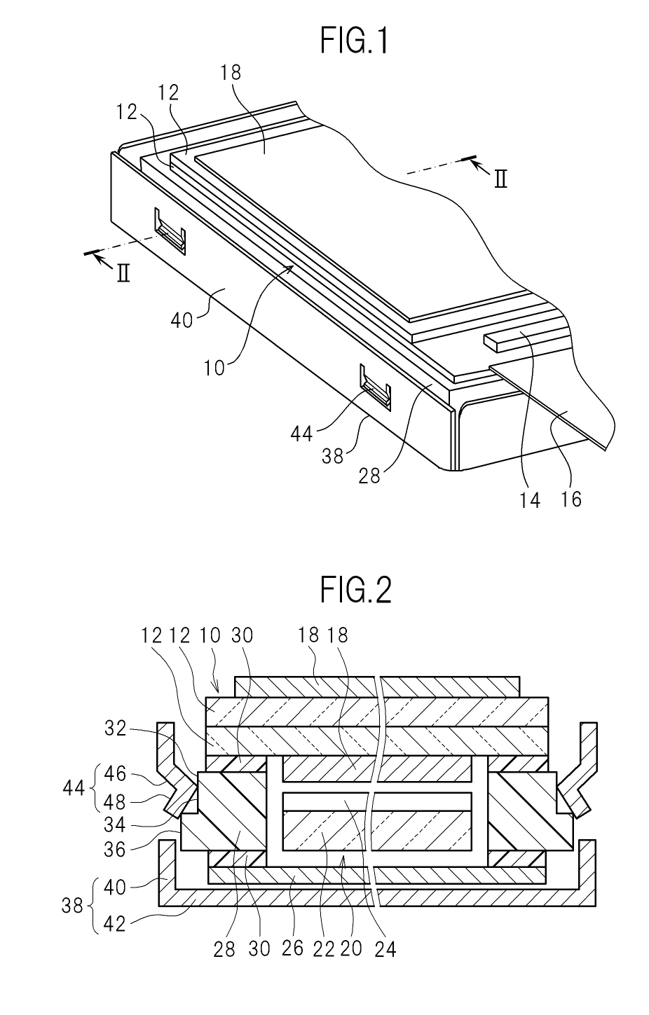

FIG. 1 is a perspective view illustrating a liquid crystal display device according to the embodiment of the present invention. FIG. 2 is a sectional view taken along the line II-II of the liquid crystal display device illustrated in FIG. 1.

The liquid crystal display device includes a liquid crystal display panel 10. The liquid crystal display panel 10 includes a pair of substrates 12 (glass substrates), and liquid crystal (not shown) is interposed therebetween. One of the substrates 12 is a thin film transistor (TFT) substrate (or array substrate) including thin film transistors, pixel electrodes, wiring, and the like, and the other of the substrates 12 is a color filter substrate. A driving method of the liquid crystal display panel 10 may be any one of an in-plane switching (IPS) method, a twisted nematic (TN) method, a vertical alignment (VA) method, and the like, and electrodes and wiring corresponding to the selected method are formed.

Onto an end portion of one of the substrates 12, an integrated circuit chip 14, which has a driver circuit for driving the liquid crystal built therein, is mounted, and a flexible printed wiring board 16 is fixed. The liquid crystal display panel 10 includes polarizing plates 18. Each of the polarizing plates 18 is adhered to a region of the substrate 12 in a manner avoiding the end portion (peripheral end portion) (adhered to a region surrounded by the peripheral end portion of the substrate 12).

The liquid crystal display device includes, as illustrated in FIG. 2, a light guide plate 22, which is a part of a backlight unit 20. The light guide plate 22 is a member for converting light of a light emitting diode (not shown) as a point light source into a planar light source to illuminate the liquid crystal display panel 10. An optical sheet group 24 is arranged between the liquid crystal display panel 10 and the light guide plate 22. The optical sheet group 24 includes a diffusion sheet, a prism sheet, and the like. Further, below the light guide plate 22 (on a side opposite to the optical sheet group 24), a reflection sheet 26 is arranged.

The liquid crystal display device includes an inner frame 28 made of, for example, a resin. The liquid crystal display panel 10 is fixed to the inner frame 28. Specifically, the inner frame 28 has a frame shape, and the liquid crystal display panel 10 is adhered to one surface (upper surface in FIG. 2) of the frame so as to cover a space inside the frame. A double-sided tape 30 is used for the adhesion. Further, the reflection sheet 26 is adhered to a surface (lower surface in FIG. 2) of the inner frame 28 on a side opposite to the surface on which the liquid crystal display panel 10 is adhered. The double-sided tape 30 is used also for this adhesion.

The backlight unit 20 is arranged inside the inner frame 28. The inner frame 28 has a side surface 32 facing a side opposite to the backlight unit 20 (outside). The side surface 32 has a recessed and projected portion formed so that a recessed portion 34 is positioned on the liquid crystal display panel 10 side. Specifically, when a direction between the liquid crystal display panel 10 and the reflection sheet 26 is defined as a thickness direction of the inner frame 28, the recessed portion 34 is formed in the side surface 32 of the inner frame 28 at an end portion on the liquid crystal display panel 10 side in the thickness direction. In other words, the recessed portion 34 is a notch. The recessed portion 34 may be formed in the entire outer periphery of the frame-shaped inner frame 28, or may be partially formed.

In the side surface 32 of the inner frame 28, a projected portion 36 is formed. Specifically, the projected portion 36 is formed in the side surface 32 of the inner frame 28 at an end portion on the reflection sheet 26 side in the thickness direction. The projected portion 36 is a portion relatively existing adjacent to the recessed portion 34.

The liquid crystal display device includes an outer frame 38 made of, for example, a metal. The material forming the outer frame 38 is harder than the material forming the inner frame 28. The outer frame 38 is arranged outside the inner frame 28. The outer frame 38 includes a periphery wall portion 40 which surrounds the inner frame 28. The outer frame 38 also includes a bottom wall portion 42. The periphery wall portion 40 is formed upright from the circumference of the bottom wall portion 42. The periphery wall portion 40 may have a structure without a hole, or a structure with the hole. The bottom wall portion 42 is opposed to a surface of the inner frame 28 on a side opposite to the liquid crystal display panel 10. Further, the reflection sheet 26 is opposed to the bottom wall portion 42.

The outer frame 38 includes an engagement piece 44. The engagement piece 44 is cut off from the periphery wall portion 40 except a portion connected to the periphery wall portion 40 (see FIG. 1). That is, the engagement piece 44 is integrally formed with the periphery wall portion 40. For example, a plate having a thickness of about 0.1 mm to 0.3 mm is subjected to punching and folding to obtain the outer frame 38 in which the engagement piece 44, the periphery wall portion 40, and the bottom wall portion 42 are integrated. The engagement piece 44 is elastically deformable. For example, the entire engagement piece 44 may be elastically deformable, or the connection portion of the engagement piece 44 and the periphery wall portion 40 may be elastically deformable. The entire outer frame 38 may be made of an elastically deformable material.

The engagement piece 44 includes a first portion 46, which is bent from the periphery wall portion 40 to extend in a first direction. The first direction is a direction which obliquely approaches the inner frame 28 while separating from the liquid crystal display panel 10. That is, the first portion 46 extends obliquely downward and inward.

The engagement piece 44 includes a second portion 48, which extends in a second direction up to a leading end of the engagement piece 44. The second direction is a direction which separates from the liquid crystal display panel 10 without approaching the inner frame 28. For example, the second direction is a direction which obliquely separates from the inner frame 28. That is, the second portion 48 extends obliquely downward and outward.

The leading end of the engagement piece 44 (leading end of the second portion 48) is positioned 0.2 mm or larger outside from a base of the second portion 48 (position connected to the first portion 46). In other words, the leading end of the second portion 48 is separated from the inner frame 28 by 0.2 mm or larger with respect to the base of the second portion 48.

As illustrated in FIG. 2, the inner frame 28 is held between the second portion 48 of the engagement piece 44 and the bottom wall portion 42. The engagement piece 44 engages with the inner frame 28, to thereby prevent detachment of the inner frame 28 from the outer frame 38. The phrase “prevent detachment” means preventing detachment in a direction separating from the bottom wall portion 42. The engagement piece 44 engages with the projected portion 36 of the recessed and projected portion of the inner frame 28. Specifically, the second portion 48 of the engagement piece 44 engages with the inner frame 28. In the example of FIG. 2, the second portion 48 engages with the inner frame 28 at a portion avoiding the leading end of the engagement piece 44. That is, the leading end of the engagement piece 44 and the inner frame 28 are in a non-contact state. Note that, as a modification example, the leading end of the engagement piece 44 and the inner frame 28 may be brought into contact with each other. The side surface 32 of the inner frame 28 is opposed to the engagement piece 44. In the example of FIG. 2, the connection portion of the first portion 46 and the second portion 48 (portion most projected inward) is brought into contact with the side surface 32 of the inner frame 28.

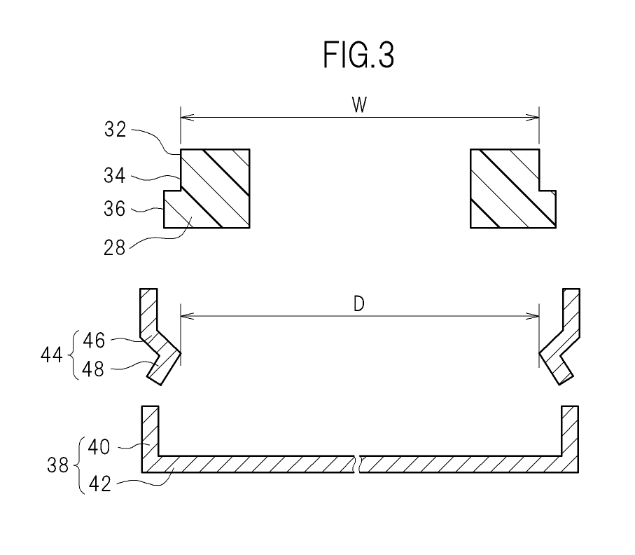

FIG. 3 is a view illustrating the inner frame 28 and the outer frame 38 under a state in which the inner frame 28 and the outer frame 38 are detached from each other (state before installing). The outer frame 38 includes a pair of opposed engagement pieces 44. An interval D between the pair of engagement pieces 44 is smaller than a width W between portions of the side surface 32 of the inner frame 28 opposed to the pair of engagement pieces 44. A difference between the interval D and the width W is 0.1 mm or larger.

When the outer frame 38 is fitted to the inner frame 28, the interval D between the pair of engagement pieces 44 becomes larger than that in the state illustrated in FIG. 3 (see FIG. 2). In this manner, the engagement piece 44 is elastically deformed, and an elastic force is applied to the inner frame 28 (side surface 32) from the engagement piece 44. With friction caused by the elastic force, the outer frame 38 and the inner frame 28 are held without a backlash.

According to this embodiment, in the engagement piece 44, the second portion 48 extends up to the leading end in a direction not approaching the inner frame 28, and hence when the inner frame 28 is fitted into the outer frame 38, the leading end of the engagement piece 44 is not brought into contact with the inner frame 28. Therefore, it is possible to prevent generation of chips of the inner frame 28 in a fitting step. Further, the engagement piece 44 can be elastically deformed to fit the inner frame 28 into the outer frame 38, and hence engagement portions of the inner frame 28 and the outer frame 38 can be greatly ensured, and detachment of the inner frame 28 can be prevented. Note that, in this embodiment, remarkable effects may be obtained when the inner frame 28 is made of a resin, but even when the inner frame 28 is made of a metal, similar effects may be obtained.

Note that, the structure of the engagement piece 44 is not limited to that in the above-mentioned embodiment, and modifications as described below can be made.

### First Modification Example

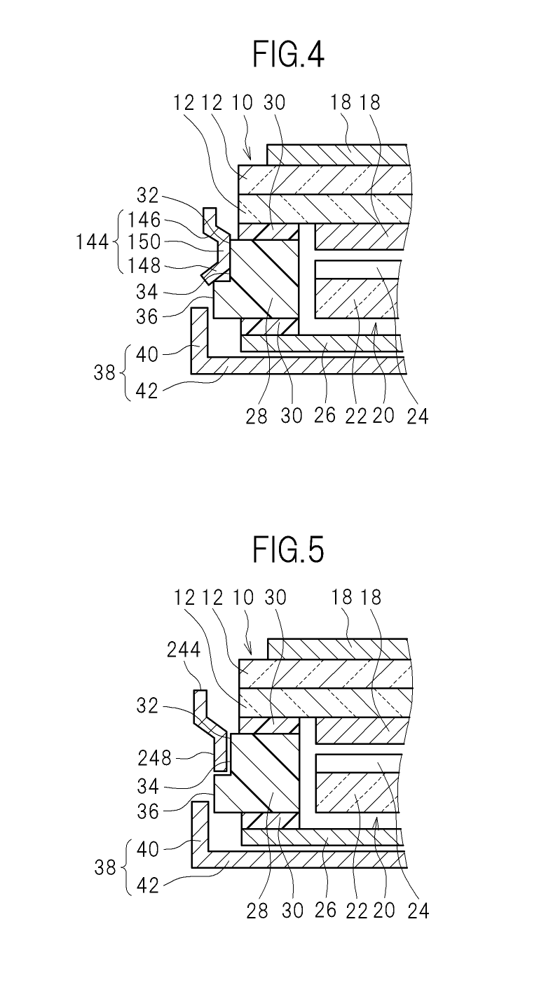

FIG. 4 is a view illustrating a liquid crystal display device according to a first modification example of the embodiment of the present invention. In this modification example, an engagement piece 144 includes a third portion 150 between a first portion 146 and a second portion 148. The third portion 150 extends from the first portion 146 toward the second portion 148, and when this direction is defined as a third direction, the third direction is a direction which separates from the liquid crystal display panel 10 without approaching the inner frame 28. Further, the third direction is a direction which does not separate from the inner frame 28. That is, the third portion 150 extends parallel to the side surface 32 of the inner frame 28. Except for the point that the engagement piece 144 includes the third portion 150, other contents of this modification example correspond to the contents described in the above-mentioned embodiment.

### Second Modification Example

FIG. 5 is a view illustrating a liquid crystal display device according to a second modification example of the embodiment of the present invention. In this modification example, a second portion 248 of an engagement piece 244 extends in a direction which does not approach nor separate from the inner frame 28. That is, the second portion 248 extends parallel to the side surface 32 of the inner frame 28. Further, a leading end of the engagement piece 244 (second portion 248) engages with the inner frame 28 (projected portion 36). Further, the second portion 248 is brought into contact with the side surface 32 of the inner frame 28. As described in the above-mentioned embodiment, the second portion 248 presses the side surface 32 of the inner frame 28 by the elastic force. Except for the second portion 248 of the engagement piece 244, other contents of this modification example correspond to the contents described in the above-mentioned embodiment.

The present invention is not limited to the embodiment described above, and various modifications may be made thereto. For example, the structure described in the embodiment may be replaced by substantially the same structure, a structure providing the same action and effect, and a structure which may achieve the same object.

What is claimed is:

1. A liquid crystal display device, comprising:
a liquid crystal display panel;
an inner frame, which is fixed to the liquid crystal display panel;
a backlight unit, which is arranged inside the inner frame; and
an outer frame, which is arranged outside the inner frame,
wherein the outer frame comprises:
a periphery wall portion, which surrounds the inner frame;
an engagement piece, which is elastically deformable and engages with the inner frame; and
a bottom wall portion, which is opposed to a surface of the inner frame on a side opposite to the liquid crystal display panel,
wherein the engagement piece comprises:
a first portion, which is bent from the periphery wall portion to extend in a first direction; and
a second portion, which extends in a second direction up to a leading end of the engagement piece,
wherein the first direction comprises a direction which obliquely approaches the inner frame while separating from the liquid crystal display panel,
wherein the second direction comprises a direction which separates from the liquid crystal display panel without approaching the inner frame,
wherein the inner frame is held between the second portion of the engagement piece and the bottom wall portion, and
wherein the second portion of the engagement piece engages with the inner frame.

2. The liquid crystal display device according to claim 1, wherein the leading end of the engagement piece engages with the inner frame.

3. The liquid crystal display device according to claim 1, wherein the second direction comprises a direction which obliquely separates from the inner frame.

4. The liquid crystal display device according to claim 3, wherein the second portion engages with the inner frame at a portion avoiding the leading end of the engagement piece.

5. The liquid crystal display device according to claim 1, wherein the engagement piece further comprises a third portion between the first portion and the second portion.

6. The liquid crystal display device according to claim 5, wherein the third portion extends in a third direction from the first portion to the second portion, the third direction comprising a direction which separates from the liquid crystal display panel without approaching the inner frame.

7. The liquid crystal display device according to claim 6, wherein the second portion engages with the inner frame at a portion avoiding the leading end of the engagement piece.

8. The liquid crystal display device according to claim 1,
wherein the inner frame has a side surface including a surface opposed to the engagement piece,
wherein the side surface comprises a recessed and projected portion formed so that a recessed portion is positioned on the liquid crystal display panel side, and
wherein the engagement piece engages with a projected portion of the recessed and projected portion.

9. The liquid crystal display device according to claim 1, wherein the engagement piece is cut off from the periphery wall portion except for a portion connected to the periphery wall portion.

10. The liquid crystal display device according to claim 1, wherein the outer frame comprises a pair of opposed engagement pieces.

11. The liquid crystal display device according to claim 10, wherein, when an interval between the pair of opposed engagement pieces becomes larger than an interval in a state before the inner frame is fitted into the outer frame, the engagement piece is elastically deformed, and an elastic force is applied to the inner frame from the engagement piece.
